(19) United States
(12) Patent Application Publication
(10) Pub. No.: US 2026/0037338 A1
(43) Pub. Date: Feb. 5, 2026

(54) DISTRIBUTED CACHING IN A MULTI-TENANT POINT-OF-SALE (POS) SYSTEM

(71) Applicant: NCR Voyix Corporation, Atlanta, GA (US)

(72) Inventor: Michael Samoelov Angel, Even Yehuda (IL)

(21) Appl. No.: 18/902,531

(22) Filed: Sep. 30, 2024

Related U.S. Application Data
(63) Continuation-in-part of application No. 18/790,406, filed on Jul. 31, 2024, now abandoned.

(51) Int. Cl. G06F 9/50; G06F 9/54; G06F 16/27; G06Q 20/20

(52) U.S. Cl. CPC G06F 9/5083; G06F 9/5016; G06F 9/547; G06F 16/273; G06Q 20/20

(57) ABSTRACT

A distributed caching system for multi-tenant retail environments addresses data isolation, synchronization, and performance challenges across cloud and edge devices. The system employs containerized architecture managed by Kubernetes®, ensuring scalability and efficient resource allocation. It implements robust multi-tenancy support, maintaining data isolation at application programming interface (API), code, memory, database, and caching levels. A schema-agnostic synchronization mechanism facilitates efficient data transfer between cloud and edge environments. The system's memory management optimizes performance across diverse devices, from cloud servers to resource-constrained point-of-sale (POS) terminals. This approach enables seamless scalability, maintains data integrity, and enhances system responsiveness, particularly during high-traffic periods. By solving conventional caching issues, the system improves overall performance, data security, and adaptability in complex retail network topologies.

### RELATED APPLICATION

The present Application claims priority to and is a continuation in part of application Ser. No. 18/790,406 filed on Jul. 31, 2024 entitled “Distributed Caching in a Multi-Tenant Point-Of-Sale (POS) system, the disclosure of which is incorporated by reference herein in its entirety.

### BACKGROUND

In existing retail systems, managing data across multiple tenants, diverse environments (cloud and edge), and various device types presents significant challenges. These challenges include maintaining data isolation between tenants, ensuring efficient data synchronization, and optimizing performance across devices with varying resource constraints. Conventional caching solutions often struggle to address these issues effectively, leading to potential data leakage, synchronization delays, and performance bottlenecks.

### BRIEF DESCRIPTION OF THE DRAWINGS

FIG. 1 is a diagram of a system for distributed caching in a multi-tenant point-of-sale (POS) system, according to an example embodiment.

FIG. 2 is a diagram of an architecture depicting varying network topologies for the distributed caching in the multi-tenant POS system of FIG. 1, according to an example embodiment.

FIG. 3 is a diagram depicting interaction for distributed caching of the various network topologies of the multi-tenant POS system of FIG. 1, according to an example embodiment.

FIG. 4 is a flow diagram of a method for providing and operating distributed caching in a multi-tenant POS system, according to an example embodiment.

FIG. 5 is a flow diagram of another method for providing and operating distributed caching in a multi-tenant POS system, according to an example embodiment.

FIG. 6 is a flow diagram of a method for providing and operating a distributed cache for different network topologies in a multi-tenant POS system, according to an example embodiment.

FIG. 7 is a flow diagram of another method for processing and operating a distributed cache for different network topologies in a multi-tenant POS system, according to an example embodiment.

### DETAILED DESCRIPTION

Conventional distributed caching techniques and retail systems face several challenges when dealing with complex multi-tenant environments and diverse device processing environments. One significant issue is the difficulty in maintaining proper data isolation between tenants while still allowing for efficient data access and management. Traditional caching solutions often struggle to enforce strict boundaries between tenant data, potentially leading to data leakage or unauthorized access across tenant boundaries. This problem is exacerbated in retail systems where multiple brands or franchises may operate on the same platform but require complete separation of their data.

Another challenge lies in the synchronization of data between cloud and edge environments. Retail systems frequently need to operate in both centralized cloud infrastructures and distributed edge locations, such as individual stores or point-of-sale (POS) devices. Conventional caching techniques often lack the flexibility to efficiently manage data consistency across these diverse environments, resulting in synchronization delays, data conflicts, and potential loss of critical transaction information. Furthermore, the varying capabilities of devices in a retail processing environment, from powerful cloud servers to resource-constrained POS terminals, pose significant difficulties for traditional caching solutions in terms of performance optimization and memory management.

Scalability is another area where conventional systems fall short. As retail operations grow and transaction volumes increase, many existing caching solutions struggle to scale effectively, leading to performance bottlenecks and degraded user experiences. This is particularly problematic in high-traffic periods such as holiday shopping seasons or flash sales, where system responsiveness is crucial.

The distributed caching technique of the system presented herein seeks to solve the conventional distributed caching problems by providing a scalable, multi-tenant aware caching system that maintains data integrity and isolation while enabling efficient data access and synchronization across cloud and edge environments. This approach aims to improve system performance, enhance data security, and support the complex requirements of modern retail ecosystems, particularly in scenarios involving multiple tenants and diverse device capabilities.

An innovative distributed caching solution is provided that is specifically designed for multi-tenant retail environments. The system employs a containerized architecture managed by Kubernetes® (K8S), allowing for seamless scalability and efficient resource allocation across both cloud and edge environments. This approach enables the system to dynamically adjust to varying workloads while maintaining consistent performance.

The distributed caching technique of the system provides a scalable, multi-tenant aware caching system that maintains data integrity and isolation while enabling efficient data access and synchronization across cloud and edge environments. This approach improves system performance, enhances data security, and supports the complex requirements of modern retail ecosystems, particularly in scenarios involving multiple tenants and diverse device capabilities.

A feature of the embodiments presented herein is its robust multi-tenancy support, which ensures data isolation at multiple levels, including application programming interface (API), code execution, memory state, database, and distributed caching. This comprehensive approach to tenant separation addresses the data leakage concerns prevalent in conventional systems. Additionally, the embodiments implement a schema-agnostic data synchronization mechanism, facilitating efficient and flexible data transfer between cloud and edge environments. This solves the synchronization challenges faced by traditional retail systems, ensuring data consistency across diverse operational contexts. The system's ability to manage memory allocation effectively, even on devices with limited resources such as 8 GB POS terminals, further demonstrates its adaptability to the varied device processing environments typical in retail systems.

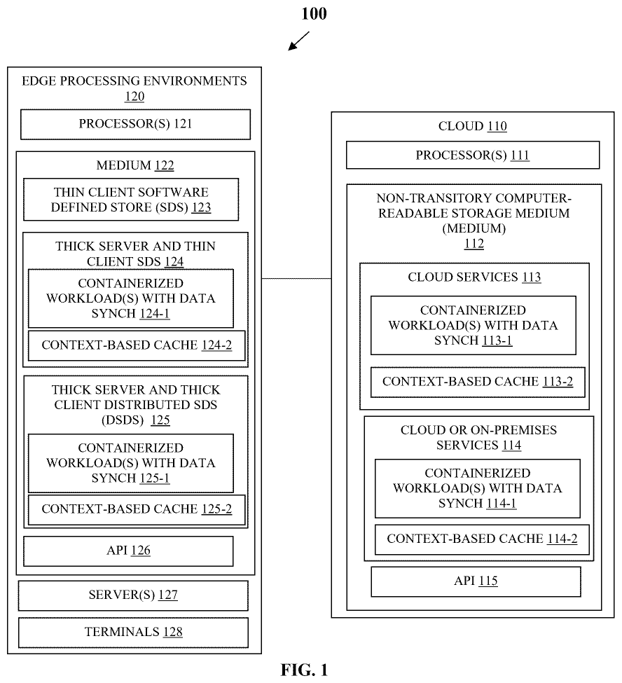

FIG. 1 is a diagram of a system 100 for distributed caching in a multi-tenant POS system, according to an example embodiment. Notably, the components are shown schematically in simplified form, with only those components relevant to understanding of the embodiments being illustrated.

Furthermore, the various components (that are identified in system 100) are illustrated and the arrangement of the components are presented for purposes of illustration only. Notably, other arrangements with more or less components are possible without departing from the teachings of distributed caching in a multi-tenant POS system, presented herein and below.

System 100 includes a cloud 110 and a plurality of varying edge processing environments 120 with varying network topologies. Cloud 110 includes at least one processor 111 and a non-transitory computer-readable storage medium (hereinafter “medium”) 112, which includes instructions for cloud services 113, cloud or on-premises services 114, and an application programming interface (API) 115. Cloud services 113 further include containerized workloads with data synch 113-1 and a context-based cache 113-2. Cloud or on-premises services 114 further include containerized workloads with data synch 114-1 and a context-based cache 114-2. The instructions when executed by processor 111 cause processor 111 to perform processing or operations discussed herein and below with respect to 113, 113-1, 113-2, 114, 114-1, 114-2, and 115.

Each edge processing environment includes one or more of, or any combination of at least one processor 121 and at least one medium, which includes instructions for a thin client software defined store (SDS) 123, a thick server and thin client SDS 124, a thick server and thick client distributed SDS (DSDS) 125, and an API 126. The thick server and thin client SDS 123 further includes containerized workloads with data synch 124-1 and a context-based cache 124-2. The thick server and thick client DSDS 125 further includes containerized workloads with data synch 125-1 and a context-based cache 125-2. The instructions when executed by processor 121 cause processor 121 to perform processing or operations discussed herein and below with respect to 123, 124, 124-1, 124-2, 125, 125-1, 125-2, and 126. Each edge processing environment also includes one or more of servers 127 and transaction terminals 128 (hereinafter just “terminals 128”).

Cloud services 113 and cloud services or on-premises services 114 are provided via a single-master code base as microservices. The microservices are customized or changed via configurations and not via changes made to their master code source. The microservices are cloud native and tenant aware such that store nodes, servers 127 and/or terminals 128 become an extension of cloud 110. The microservices are deployable to any processing environment or device where it is necessary for business continuity in the event of network outages, device outages, slow network response times and/or slow device response times. For example, the microservices are deployable to any hosted cloud, such as cloud 110, store servers 127, and/or store terminals 128.

The microservices cooperate to provide a retail business with continuity of the functionality associated their POS system, which is needed to sell items or services to their customers with high availability and flexibility should any device and/or network issues be experienced by the business. By way of example only, the microservices include a complete fully operational POS system with payment microservices, loyalty microservices, fuel microservices, pharmacy microservices, merchandising microservices, monitoring microservices, authentication microservices, analytic microservices, self-service microservices, and others.

The microservices are unified and cooperate to provide a highly available and flexible POS system to a business. A business's edge devices are connected and interfaced across multiple channels (i.e., Omni-channel) via the microservices. For example, the unified POS system provided by a given business's configurations of the microservices allow edge devices associated with business channels for grocery, fuel, pharmacy, and a quick service restaurant. Should any given edge device fail or should network connectivity to cloud 110 fail, the microservices are flexibly and dynamically reconfigured to provide continuity in the business's POS system.

Workloads define process flows within a unified POS system for a given processing environment (e.g., cloud 110 and processing environments 120. Each workload in a business's unified POS system is containerized and managed by Kubernetes® (K8S). A given workload includes one or more microservices necessary to process the workload. Each microservice in the workload respects the platform tenant identifier for data isolation including API level e.g., use of relevant headers, etc.), code level (e.g., process each request in the correct tenant, store and POS group context, etc.), memory state isolation or memory-isolated (e.g., static fields, dependency injection, etc.), database level (e.g., either database instance or discriminating database table column, etc.), distributed caching level (e.g., keep each unit of data in a dedicated context, etc.). Stateless PODs (i.e., smallest deployable unit of computing in K8S—point of delivery (POD)) are used ensuring dynamic and flexible scaling. Master-slave relationships are used for databases for efficient caching and memory footprints are maintained to remain under 8 GBs. Each business configuration is deployed, monitored, and the corresponding business's transaction data are data synchronized.

The microservices within a containerized workload with data synch (113-1, 114-1, 124-1, and/or 125-1) communicate with API 126. The microservices are configured to provide a unique tenant identifier within the API headers of the API calls. The tenant identifier permits the stateless PODs to access the corresponding context-based cache (113-2, 114-2, 124-2, and/or 125-2) and obtain the accurate data for the processing context of the corresponding microservices and their workloads. The data required for a given microservice is stored in the corresponding context-based cache (113-2, 114-2, 124-2, and/or 125-2) rather than the PODs themselves. When a POD needs to access or modify data, it interacts with the context-based cache (113-2, 114-2, 124-2, and/or 125-2) using the tenant identifier to ensure it is working with the correct data set. This approach also ensures memory state isolation by handling static fields and dependency injection in a manner that respects tenant boundaries within the workloads, even with the stateless POD environment.

In an embodiment, and to support data elements with a time-critical nature, cache (113-2, 114-2, 124-2, and/or 125-2) supports an optional in-process “near cache” with pre-load capabilities. This near cache is divided into domains and context (e.g., tenant, type of data/configuration, store identifier, region identifier, etc.), allowing data to be segmented by tenant and data type. When a data element is marked by a service code for preload, it is placed both in the distributed cache and copied in local memory of the consuming POD. Other PODs in the cluster self-tune to the same domain and context based on similarities with previously received requests within a given time window. Then, upon receiving notifications of any data changes (e.g., additions, deletions, updates) relating to the domain and context to which they have self-tuned, the PODs will synchronize those changes with data stored in the near cache (e.g., modifying existing data or preloading the data within their own local memory space). If the next service API call is routed to any of these PODs, they will have the needed data ready in memory and will not have to make a round trip to the slower remote cache. PODs become tuned to a domain and context by the fact that they received an API call related to this domain and context. This allows use of a load-balancer that routes API calls to a subset of PODs in a large cluster based on tenant ID. PODs do not have to be preconfigured and start off “context neutral”. As API calls are routed to them, they automatically become temporarily tuned to keep serving requests for this domain and context very fast. If no API calls arrive to the POD for a given domain and context for some configurable duration, this context cools down, is cleared, and stops preloading data for that context.

Since the PODs are stateless, system 100 provides scaling and flexibility while they still operate within a correct tenant context for each microservice request that are asked to process. For example, PODs can be replicated or terminated based on processing loads and responsiveness within a given processing environment without losing critical data for the workloads. Furthermore, K8S is the de facto standard for container orchestration which enables efficient management and scaling of the containerized workloads with data synch (113-1, 114-1, 124-1, and/or 125-1). Thus, distributed caching services can scale capabilities independent of the microservices' logic and execution.

Each workload includes a data synch microservice, which is schema agnostic allowing data to be channeled between the cloud processing environment 110 and the edge processing environments 120 without requiring predefined data schemas. This approach removes potential “roadblocks” for new features and new data that may be needed by a business. Transaction data is distributed while consistency is maintained between the microservices of the cloud processing environment 110 and the microservices of the edge processing environments 120. Network topologies can be switched dynamically while the data synch microservice ensures that an original tenant identifier associated with an original network topology accesses a synchronized context-based cache (113-2, 114-2, 124-2, and/or 125-2) associated with a new tenant identifier for a new network topology. The microservices provide the tenant identifier via the API header in the API calls. As a result, the microservices can be terminated and instantiated as different instances and configured to provide the tenant identifier for a given network topology within the API headers of the API calls. The PODs are stateless and obtain the correct data from the correct context-based cache (113-2, 114-2, 124-2, and/or 125-2) based on the tenant identifier in the API headers.

Each workload within the cloud processing environment 110 and the edge processing environments 120 also includes replicated and synchronized data stores for transaction data. Such that when a given context-based cache (113-2, 114-2, 124-2, and/or 125-2) lacks sufficient data or memory is close to being reached, the appropriate data can be retrieved for a POD from the data store. A master-slave relationship for the data stores is maintained such that a master store handles write operations and replicates data to the slave databases forcing dynamic and real-time updates within the context-based cache (113-2, 114-2, 124-2, and/or 125-2). Data read operations are distributed across slave nodes while write operations are centralized in a master node.

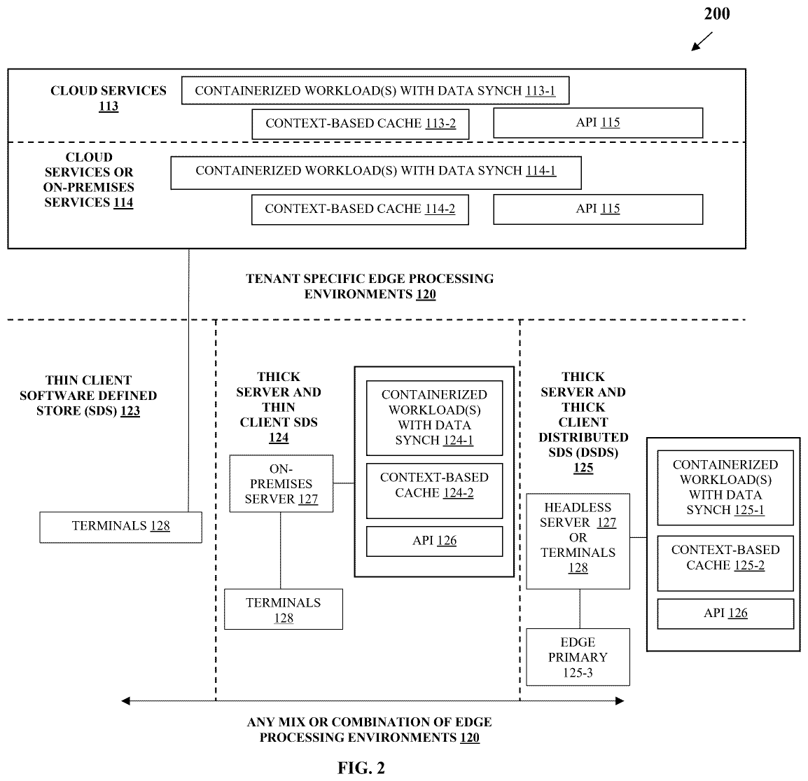

FIG. 2 is a diagram of an architecture 200 depicting varying network topologies for the distributed caching in the multi-tenant POS system of FIG. 1, according to an example embodiment. Cloud 110 includes cloud services 113, which include containerized workloads with data synch 113-1, a context-based cache 113-2, and API 115. Again, the workloads include business microservices for business transactions. Cloud 110 also includes cloud or on-premises services 114, which include containerized workloads with data synch 114-1, a context-based cache 114-2, and API 115.

The edge processing environments 120 include 1 or more of the three primary configurations for the containerized workloads with data synch (113-1, 124-1, and 125-1). The first network topology is supported by the configured microservices associated with the thin client SDS 123. In this network topology, one or more terminals 128 perform business transactions via, the microservices associated with the containerized workloads with data synch (113-1 and/or 114-1), each POD retrieves data necessary for the transactions from the isolated context-based cache (113-2 and/or 114-2).

The second network topology is supported by configured microservices associated with the thick server and thin client SDS 124. Here, the on-premises store server 127 hosts the microservices associated with the containerized workloads with data synch 124-1 and transaction data for the workloads are retrieved by PODs based the API headers of API calls for API 126 from context-based cache 124-2. The thin client terminals 128 in this network topology process business transactions via the containerized workloads with data synch 124-1 associated with the on-premises server 127, the correct transaction data needed for the transactions are isolated and accessible to the PODs via the server hosted context-based cache 124-2.

The third network topology is supported by configured microservices associated with the thick server and thick client DSDS 125. Here, either a headless on-premises store server 127 or the terminals 128 hosts the containerized workloads with data synch 125-1. Each POD associated with each workload obtains the necessary transaction data for the business transactions from the isolated context-based cache 125-2 based on the API headers of API calls for API 126 made by the configured microservices of the workloads. The edge primary device 125-3 is intended to illustrate that either a headless server 127 or a terminal 128 can host the containerized workloads with data synch 125-1 and the corresponding context-based cache 125-2.

Notably, a single store can deploy a mixture of the network topologies utilizing any mixture of the microservice configurations for the thin client SDS 123, the thick server and thin client SDS, and/or the thick server and thick client DSDS 125. Furthermore, when network or device problems are detected, the business can dynamically and rapidly switch to a different network topology to maintain continuity of the business and high availability of their unified and multi-tenant POS system. Changes to the network topology can be automatically and dynamically processed utilizing K8S by removing and adding new instantiated microservices configured with a new tenant identifier.

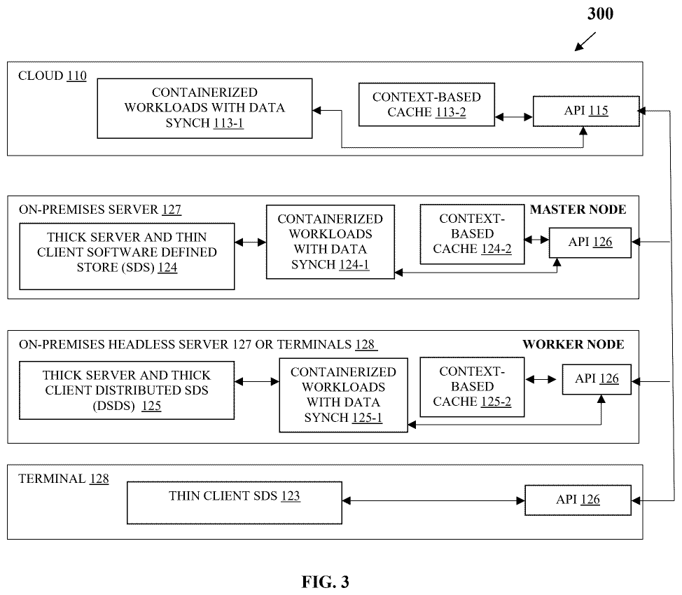

FIG. 3 is a diagram depicting interactions 300 for distributed caching of the various network topologies of the multi-tenant POS system of FIG. 1, according to an example embodiment. The cloud 110 provides the containerized workloads with data synch 113-1 and an isolated context-based cache 113-2. The microservices of the workloads cause PODs to perform operations utilizing transaction data. The microservices utilize API headers associated with API calls of API 115 to provide a tenant identifier for the tenant of the cloud processing environment 110, the PODs are stateless but provided the correct and up-to-date transaction data based on the tenant identifier of the API header.

The thick server and thin client SDS 124 of an on-premises server 127 utilizes containerized workloads with data synch 124-1 and an isolated context-based cache 124-2. The microservices of the workloads cause PODs to perform operations utilizing transaction data. The microservices utilize API headers associated with API calls of API 126 to provide a tenant identifier for the tenant of the on-premises server 127; again, the PODs are stateless but provided the correct and up-to-date transaction data based on the tenant identifier of the API header.

The on-premises headless server 127 or terminals 128 of the thick server and thick client DSDS 125 utilize containerized workloads with data synch 125-1 and an isolated context-based cache 125-2. The microservices of the workloads cause PODs to perform operations utilizing transaction data. The microservices utilize API headers associated with API calls of API 126 to provide a tenant identifier for the tenant of the on-premises server 127 or terminal 128; again, the PODs are stateless but provided the correct and up-to-date transaction data based on the tenant identifier of the API header.

Each terminal of the thin client SDS 123 utilizes containerized workloads with data synch (113-1 and/or 114-1) 123 and an isolated context-based cache (113-2 and/or 114-2). The microservices of the workloads cause PODs to perform operations utilizing transaction data. The microservices utilize API headers associated with API calls of API 115 to provide a tenant identifier for the tenant of the cloud 110; again, the PODs are stateless but provided the correct and up-to-date transaction data based on the tenant identifier of the API header.

Notably, when a network or device issue is encountered, a different and operational network topology is initiated to maintain high available of business operations. This is dynamic and in real time such that it appears transparent to the business.

System 100 provides exceptional flexibility and adaptability for diverse retail processing environments. By accommodating multiple tenants with different network topologies, the system can support various business structures within a single infrastructure, from small single-store operations to large multi-brand franchises. This flexibility allows retailers to scale their operations seamlessly, adding new stores or brands without requiring separate system deployments. The ability to deploy services “anywhere it makes sense for business continuity (e.g., hosted cloud 110, store server 127, and/or POS terminal 128)” ensures that each tenant can optimize their network configuration based on their specific needs and constraints, whether they require a cloud-heavy approach or a more distributed edge-based setup.

The system 100 for distributed caching in a multiple tenant POS system offers significant benefits in the context of multi-tenant retail processing environments. By implementing a containerized architecture managed by K8S, the system 100 enables efficient resource allocation and seamless scalability across both cloud processing environments 110 and edge processing environments 120 of varying network topologies. This approach allows for dynamic adjustment to varying workloads while maintaining consistent performance, which is crucial in retail scenarios with fluctuating demand. The system's ability to support multiple tenants with robust data isolation at various levels (API, code, memory, database, and caching) ensures data security and privacy, a critical concern in multi-tenant retail systems. Furthermore, the schema-agnostic data synchronization mechanism facilitates efficient and flexible data transfer between cloud and edge environments, addressing the synchronization challenges faced by traditional retail systems and ensuring data consistency across diverse operational contexts. This is particularly beneficial for retail operations that span multiple locations or utilize a mix of cloud and edge devices.

In an embodiment, the system 100 enables flexible data transfer between cloud and edge environments without relying on predefined schemas. This is achieved through the use of a dynamic data mapping system that interprets and translates data structures on-the-fly. The system utilizes flexible data formats such as JavaScript Object Notation® (JSON) for data transfer, allowing it to handle diverse data structures across different tenants and environments. When synchronizing data, the system 100 dynamically analyzes the incoming data fields and maps them to the appropriate data structures in the target environment. This approach eliminates the need for rigid schema definitions and allows the system to adapt seamlessly to evolving data requirements across various retail contexts. By removing the constraints of fixed schemas, the system 100 can easily accommodate new features and data types without requiring system-wide updates, thus enhancing the overall flexibility and scalability of a multi-tenant POS system.

In an embodiment, to maintain memory footprints under 8 GB on resource-constrained POS terminals 128, the system 100 employs several advanced memory management techniques. These include the use of efficient data structures optimized for low memory consumption, implementation of memory pooling to reduce allocation overhead, and application of data compression algorithms to minimize the size of cached data. The system 100 also implements a sophisticated cache management strategy, utilizing a combination of least-recently-used (LRU) and priority-based eviction policies to ensure optimal use of limited memory resources. This approach allows the system 100 to prioritize critical data for local caching while intelligently offloading less frequently accessed data to master-slave data stores. Furthermore, the system 100 employs a dynamic balancing mechanism that continuously adjusts the ratio of locally cached data to tenant hosted master-slave data stores based on available memory, network conditions, and usage patterns. This adaptive approach ensures responsive performance on POS terminals while minimizing local memory usage.

In an embodiment, to address potential conflicts and race conditions in data synchronization across different network topologies, the system 100 implements a robust conflict resolution strategy. This strategy incorporates a version control mechanism for each data entry, allowing the system 100 to detect and reconcile conflicting updates efficiently. When multiple edge devices attempt to update the same data simultaneously, the system employs an optimistic locking mechanism combined with conflict-free replicated data types (CRDTs) to manage concurrent modifications. In the event of a conflict, the system 100 applies a set of predefined resolution rules, which may include timestamp-based resolution, priority-based resolution, or custom merge functions depending on the data type and business logic. To ensure eventual consistency across all nodes in various network topologies, the system 100 utilizes a gossip protocol for propagating updates and a background reconciliation process that periodically scans for and resolves any lingering inconsistencies. This multi-layered approach allows the system 100 to maintain data integrity and consistency across diverse retail environments, even in the face of network disruptions or temporary disconnections.

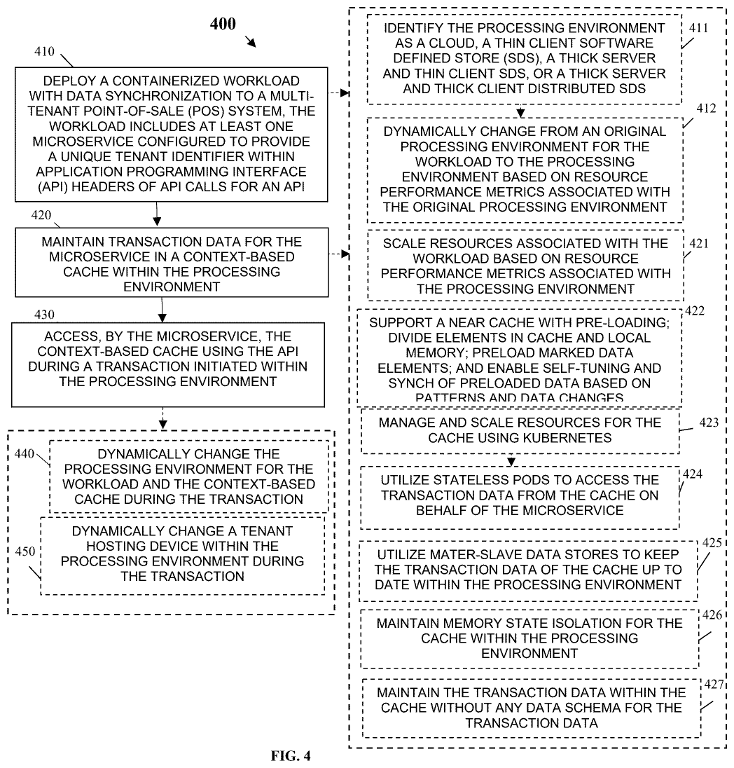

The above-referenced embodiments and other embodiments are now discussed with reference to FIGS. 4-7. FIG. 4 is a flow diagram of a method 400 for providing and operating distributed caching in a multi-tenant POS system, according to an example embodiment. The software module(s) that implements the method 400 is referred to as a “context-based distributed cache manager.” The context-based distributed cache manager is implemented as executable instructions programmed and residing within memory and/or a non-transitory computer-readable (processor-readable) storage medium and executed by one or more processors of one or more devices. The processor(s) of the device(s) that executes the context-based distributed cache manager are specifically configured and programmed to process the context-based distributed cache manager. The context-based distributed cache manager may have access to one or more network connections during its processing. The network connections can be wired, wireless, or a combination of wired and wireless.

In an embodiment, the devices that execute the context-based distributed cache manager is cloud 110, servers 127, and/or terminals 127. In an embodiment, the context-based distributed cache manager is cloud services 113, containerized workloads with data synch 113-1, context-based cache 113-2, cloud or on-premises services 114, containerized workloads with data synch 114-1, context-based cache 114-2, API 115, thin client SDS 123, thick server and thin client SDS 124, containerized workloads with data synch 124-1, context-based cache 124-2, thick server and thick client DSDS 124, containerized workloads with data synch 125-1, context-based cache 125-2, and/or API 126.

At 410, the context-based distributed cache manager deploys a containerized workload with data synch to a multi-tenant POS system. The workload includes at least one microservice configured to provide a unique tenant identifier within API headers of API calls for an API.

In an embodiment, at 411, the context-based distributed cache manager identifies the processing environment as a cloud processing environment, a think client SDS, a thick server and thin client SDS, or a thick server and thick client DSDS. In an embodiment of 411 and at 412, the context-based distributed cache manager dynamically changes from an original processing environment for the workload to the processing environment based on resource performance metrics associated with the original processing environment.

At 420, the context-based distributed cache manager maintains transaction data for the microservice in a context-based cache within the processing environment. In an embodiment, at 421, the context-based distributed cache manager scales resources associated with the workload based on resource performance metrics associated with the processing environment.

In an embodiment, the context-based distributed cache manager manages a memory size for the cache to ensure a predefined memory size for a tenant hosting device of the processing environment. In an embodiment, at 422, the context-based distributed cache manager supports a near cache with pre-load capabilities for time-critical data elements. The context-based distributed cache manager divides the near cache into domains and contexts and preloads marked data elements in both the context-based cache and local memory. This enables self-tuning and synchronization of preloaded data across processing units based on request patterns and data changes.

In an embodiment, a 423, the context-based distributed cache manager manages and scales resources for the cache using K8S. In an embodiment of 423 and at 424, the context-based distributed cache manager utilizes stateless PODs to access transaction data from the cache on behalf of the microservice.

In an embodiment, at 425, the context-based distributed cache manager utilizes a master data store and a slave data store to keep the transaction data up to date within the processing environment. In an embodiment, at 426, the context-based distributed cache manager maintains memory state isolation for the cache within the processing environment. In an embodiment, at 427, the context-based distributed cache manager maintains the transaction data within the cache without any data schema for the transaction data (i.e., the cache is data schema agnostic).

At 430, the microservice accesses the cache using the API during a transaction initiated within the processing environment. In an embodiment, at 440, the context-based distributed cache manager dynamically changes the processing environment for the workload and the cache during the transaction to provide high availability of the multi-tenant POS system. In an embodiment, at 450, the context-based distributed cache manager dynamically changes a tenant hosting device within the processing environment during the transaction to provide high availability of the multi-tenant POS system.

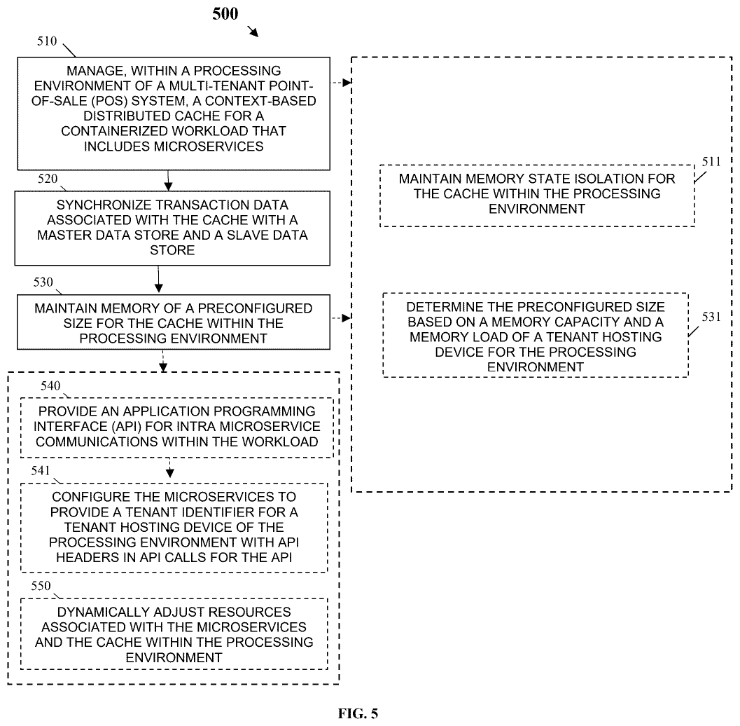

FIG. 5 is a flow diagram of another method 500 for providing and operating distributed caching in a multi-tenant POS, according to an example embodiment. The software module(s) that implements the method 500 is referred to as a “distributed multi-tenant POS system cache manager.” The distributed multi-tenant POS system cache manager is implemented as executable instructions programmed and residing within memory and/or a non-transitory computer-readable (processor-readable) storage medium and executed by one or more processors of one or more device(s). The processors that execute the distributed multi-tenant POS system cache manager are specifically configured and programmed for processing the distributed multi-tenant POS system cache manager. The distributed multi-tenant POS system cache manager may have access to one or more network connections during its processing. The network connections can be wired, wireless, or a combination of wired and wireless.

In an embodiment, the devices that execute the distributed multi-tenant POS system cache manager is cloud 110, servers 127, and/or terminals 127. In an embodiment, the distributed multi-tenant POS system cache manager is cloud services 113, containerized workloads with data synch 113-1, context-based cache 113-2, cloud or on-premises services 114, containerized workloads with data synch 114-1, context-based cache 114-2, API 115, thin client SDS 123, thick server and thin client SDS 124, containerized workloads with data synch 124-1, context-based cache 124-2, thick server and thick client DSDS 124, containerized workloads with data synch 125-1, context-based cache 125-2, API 126, and/or method 400. In an embodiment, the distributed multi-tenant POS system cache manager presents another and, in some ways, and enhanced processing perspective from that which was described above for method 400 of FIG. 4.

At 510, the distributed multi-tenant POS system cache manager manages, within a processing environment of a multi-tenant POS system a context-based distributed cache for a containerized workload that includes a plurality of microservices. In an embodiment, at 511, the distributed multi-tenant POS system cache manager maintains memory state isolation for the cache within the processing environment.

At 520, the distributed multi-tenant POS system cache manager synchronizes transaction data associated with the cache with a master data store and a slave data store. The master data store performs writes and updates the slave data store forcing an update to the transaction data in the cache. Reads or non-volatile access is performed directly from the cache and/or the slave data store.

At 530, the distributed multi-tenant POS system cache manager maintains memory of a preconfigured size for the cache within the processing environment. In an embodiment, at 531, the distributed multi-tenant POS system cache manager determines the predetermined size based on a memory capacity and a real-time memory load of a tenant hosting device for the processing environment.

In an embodiment, at 540, the distributed multi-tenant POS system cache manager provides an PI for intra microservice communications within the workload. In an embodiment of 540 and at 541, the distributed multi-tenant POS system cache manager configures the microservices to provide a tenant identifier for a tenant hosting device of the processing environment within API headers in API calls for the API.

In an embodiment, at 550, the distributed multi-tenant POS system cache manager dynamically adjusts resources associated with the microservices and the cache within the processing environment. This provides high availability and uninterrupted access to the multi-tenant POS system.

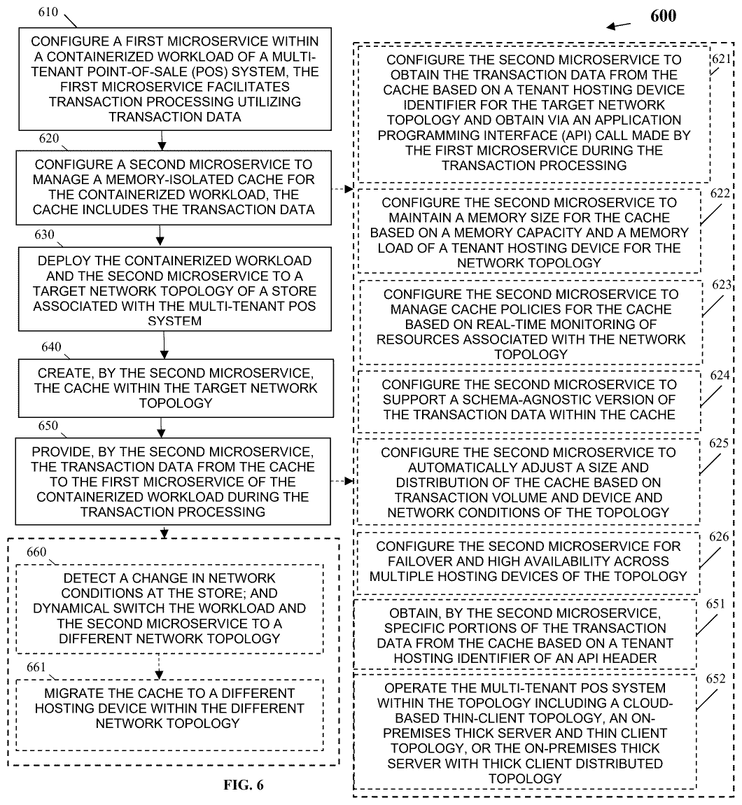

FIG. 6 is a flow diagram of a method for providing and operating a distributed cache for different network topologies in a multi-tenant POS system, according to an example embodiment. The software module(s) that implements the method 600 is referred to as a “multi-tenant POS system network topology distributed cache manager.” The multi-tenant POS system network topology distributed cache manager is implemented as executable instructions programmed and residing within memory and/or a non-transitory computer-readable (processor-readable) storage medium and executed by one or more processors of one or more device(s). The processors that execute the multi-tenant POS system network topology distributed cache manager are specifically configured and programmed for processing the multi-tenant POS system network topology distributed cache manager. The multi-tenant POS system network topology distributed cache manager may have access to one or more network connections during its processing. The network connections can be wired, wireless, or a combination of wired and wireless.

In an embodiment, the devices that execute the multi-tenant POS system network topology distributed cache manager is cloud 110, servers 127, and/or terminals 127. In an embodiment, the multi-tenant POS system network topology distributed cache manager is cloud services 113, containerized workloads with data synch 113-1, context-based cache 113-2, cloud or on-premises services 114, containerized workloads with data synch 114-1, context-based cache 114-2, API 115, thin client SDS 123, thick server and thin client SDS 124, containerized workloads with data synch 124-1, context-based cache 124-2, thick server and thick client DSDS 124, containerized workloads with data synch 125-1, context-based cache 125-2, API 126, method 400, and/or method 500. In an embodiment, the multi-tenant POS system network topology distributed cache manager presents another and, in some ways, and enhanced processing perspective from that which was described above for method 400 of FIG. 4 and method 500 of FIG. 5.

At 610, the multi-tenant POS system network topology distributed cache manager configures at least one first microservice within a containerized workload of a multi-tenant POS system. The first microservice facilitates transaction processing utilizing transaction data.

At 620, the multi-tenant POS system network topology distributed cache manager configures at least one second microservice to manage a memory-isolated distributed cache for the containerized workload. The cache includes the transaction data.

In an embodiment, at 621, the multi-tenant POS system network topology distributed cache manager configures the second microservice to obtain the transaction data from the cache based on a tenant hosting device identifier for a target network topology. The multi-tenant POS system network topology distributed cache manager obtains the tenant hosting device identifier via an API call made by the first microservice during the transaction processing.

In an embodiment, at 622, the multi-tenant POS system network topology distributed cache manager configures the second microservice to maintain a memory size for the cache. The memory size for the cache is based on a memory capacity and a memory load of a tenant hosting device for the network topology.

In an embodiment, at 623, the multi-tenant POS system network topology distributed cache manager configures the second microservice to manage cache policies for the cache. The cache policies are managed based on real-time monitoring of resources associated with the network topology.

In an embodiment, at 624, the multi-tenant POS system network topology distributed cache manager configures the second microservice to support a schema agnostic version of the transaction data within the cache. That is, the transaction data is not associated with any predefined data schema.

In an embodiment, at 625, the multi-tenant POS system network topology distributed cache manager configures the second microservice to automatically adjust a size and a distribution of the cache. This is based on transaction volume for the transaction processing and network conditions associated with the network topology.

In an embodiment, at 626, the multi-tenant POS system network topology distributed cache manager configures the second microservice for failover and high availability of the workload and the cache for the multi-tenant POS system. This is done across multiple hosting devices of the network topology.

At 630, the multi-tenant POS system network topology distributed cache manager deploys the containerized workload and the second microservice to the target network topology of a store associated with the multi-tenant system. Notably, the target network topology and be dynamically changed to provide failover and high availability for the containerized workload and cache of the multi-tenant POS system.

At 640, the second microservice creates the cache within the target network topology. This is done when the containerized workload and the second microservice are instantiated within the target network topology.

At 650, the second microservice provides the transaction data from the cache to the first microservice of the containerized workload during the transaction processing. That is, all transaction data is provided to and obtained from the cache being managed by the second microservice during the transaction processing within the target network topology.

In an embodiment, at 651, the second microservice obtains specific portions of the transaction data from the cache based on a tenant hosting device identifier. The first microservice issues calls to provide or obtain transaction data during the transaction processing using API calls of an API. API headers provide the second microservice with the hosting device identifier to ensure the proper transaction data with the proper context is written to or obtained from the cache.

In an embodiment, at 652, the multi-tenant POS system network topology distributed cache manager operates the multi-tenant POS system within the target network topology. The target network topology is one or more of a cloud-based thin client topology, an on-premises thick server and thin client topology, and/or an on-premises thick server and thick client topology.

In an embodiment, at 660, the multi-tenant POS system network topology distributed cache manager detects a change in network conditions at the store. Responsive to the change, the multi-tenant POS system network topology distributed cache manager dynamically switches the containerized workload and the second microservice to a different network topology. In an embodiment of 660 and at 661, the multi-tenant POS system network topology distributed cache manager migrates the cache to the different hosting device within the different network topology.

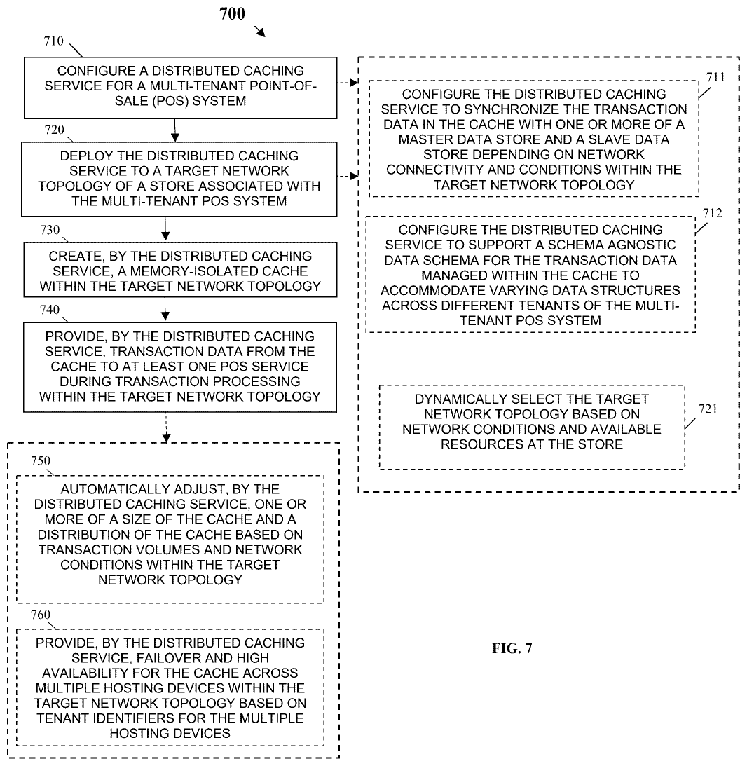

FIG. 7 is a flow diagram of another method for processing and operating a distributed cache for different network topologies in a multi-tenant POS system, according to an example embodiment. The software module(s) that implements the method 500 is referred to as a “varying network topology distributed cache manager.” The varying network topology distributed cache manager is implemented as executable instructions programmed and residing within memory and/or a non-transitory computer-readable (processor-readable) storage medium and executed by one or more processors of one or more device(s). The processors that execute the varying network topology distributed cache manager are specifically configured and programmed for processing the varying network topology distributed cache manager. The varying network topology distributed cache manager may have access to one or more network connections during its processing. The network connections can be wired, wireless, or a combination of wired and wireless.

In an embodiment, the devices that execute the varying network topology distributed cache manager is cloud 110, servers 127, and/or terminals 127. In an embodiment, the varying network topology distributed cache manager is cloud services 113, containerized workloads with data synch 113-1, context-based cache 113-2, cloud or on-premises services 114, containerized workloads with data synch 114-1, context-based cache 114-2, API 115, thin client SDS 123, thick server and thin client SDS 124, containerized workloads with data synch 124-1, context-based cache 124-2, thick server and thick client DSDS 124, containerized workloads with data synch 125-1, context-based cache 125-2, API 126, method 400, method 500, and/or method 600. In an embodiment, the varying network topology distributed cache manager presents another and, in some ways, and enhanced processing perspective from that which was described above for method 400 of FIG. 4, method 500 of FIG. 5, and method 600 of FIG. 6.

At 710, varying network topology distributed cache manager configures a distributed caching service for a multi-tenant POS system. The distributed caching service includes one or more cache management microservices.

In an embodiment, at 711, the varying network topology distributed cache manager configures the distributed caching service to synchronize transaction data in a memory-isolated cache of the target network topology with one or more of a master data store and a slave data store. Synchronization is based on or depends on network connectivity and conditions detected within the target network topology.

In an embodiment, at 712, the varying network topology distributed cache manager configure the distributed caching service to support a schema-agnostic data schema for the transaction data being managed within the cache by the distributed caching service. This accommodates varying data structures for transaction data across different tenants of the multi-tenant POS system.

At 720, the varying network topology distributed cache manager deploys the distributed caching service to the target network topology of a store associated with the multi-tenant POS system. In an embodiment, at 721, the varying network topology distributed cache manager dynamically selects the target network topology from a plurality of available network topologies based on real-time conditions and available resources of the store.

At 730, the distributed caching service creates the memory-isolated cache within the target network topology. Once the cache is created, transaction data is written to and obtained from the cache via the distributed caching service.

At 740, the distributed caching service provides transaction data from the cache to at least one POS service during transaction processing within the target network topology. In an embodiment, the POS service is at least one microservice of a containerized workload configured for operation within the target network topology.

In an embodiment, at 750, the distributed caching service automatically adjusts one or more of a size of the cache and a distribution of the cache. This is done based on transaction volumes associated with transaction processing and network conditions within the target network topology.

It should be appreciated that where software is described in a particular form (such as a component or module) this is merely to aid understanding and is not intended to limit how software that implements those functions may be architected or structured. For example, modules are illustrated as separate modules, but may be implemented as homogenous code, as individual components, some, but not all of these modules may be combined, or the functions may be implemented in software structured in any other convenient manner.

Furthermore, although the software modules are illustrated as executing on one piece of hardware, the software may be distributed over multiple processors or in any other convenient manner.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus, the following claims are hereby incorporated into the Description of the Embodiments, with each claim standing on its own as a separate exemplary embodiment.

1. A method comprising:
deploying a containerized workload with data synchronization to a processing environment of a multi-tenant point-of-sale (POS) system, wherein the containerized workload with data synchronization includes at least one microservice configured to provide a unique tenant identifier within application programming interface (API) headers of API calls for an API;
maintaining transaction data for the at least one microservice in a context-based cache within the processing environment; and
accessing, by the at least one microservice, the context-based cache using the API during a transaction initiated within the processing environment.

2. The method of claim 1, wherein deploying further includes identifying the processing environment as a cloud, a thin client software defined store (SDS), a thick server and thin client SDS, or a thick server and thick client distributed SDS.

3. The method of claim 2, wherein identifying further includes dynamically changing from an original processing environment for the containerized workload with data synchronization to the processing environment based on resource performance metrics associated with the original processing environment.

4. The method of claim 1, wherein maintaining further includes scaling resources associated with the containerized workload with data synchronization based on resource performance metrics associated with the processing environment.

5. The method of claim 1, wherein maintaining further includes managing a memory size of the context-based cache to ensure a predefined memory size for a tenant device of the processing environment.

6. The method of claim 1, wherein maintaining further includes managing and scaling resources associated with the context-based cache within the processing environment using KUBERNETES.

7. The method of claim 6, wherein managing and scaling further includes utilizing stateless smallest units of deploy computing units (PODs) to access the transaction data from the context-based cache on behalf of the at least one microservice.

8. The method of claim 1, wherein maintaining further includes utilizing a master data store and a slave data store to keep the transaction data of the context-based cache up to date within the processing environment.

9. The method of claim 1, wherein maintaining further includes maintaining memory state isolation for the context-based cache within the processing environment.

10. The method of claim 1, wherein maintaining further includes:
supporting a near cache with pre-load capabilities for time-critical data elements;
dividing the near cache into domains and contexts;
preloading marked data elements in both the context-based cache and local memory; and
enabling self-tuning and synchronization of preloaded data across processing units based on request patterns and data changes.

11. The method of claim 1, further comprising dynamically changing the processing environment for the containerized workload with data synchronization and the context-based cache during the transaction.

12. The method of claim 1, further comprising dynamically changing a tenant hosting device within the processing environment during the transaction.

13. A method comprising:
managing, within a processing environment of a multi-tenant point-of-sale (POS) system, a context-based distributed cache for a containerized workload comprising a plurality of microservices;
synchronizing transaction data associated with the context-based distributed cache with a master data store and a slave data store; and
maintaining memory of a preconfigured size for the context-based distributed cache within the processing environment.

14. The method of claim 13, further comprising providing an application programming interface (API) for intra microservice communications within the containerized workload.

15. The method of claim 14, wherein providing further includes configuring the microservices to provide a tenant identifier for a tenant hosting device of the processing environment with API headers in API calls for the API.

16. The method of claim 13, further comprising dynamically adjusting resources associated with the microservices and the context-based distributed cache within the processing environment.

17. The method of claim 13, wherein managing further includes maintaining memory state isolation for the context-based distributed cache within the processing environment.

18. The method of claim 13, wherein maintaining further includes determining the preconfigured size based on a memory capacity and a memory load of a tenant hosting device for the processing environment.

19. A system comprising:
at least one processor and a non-transitory computer-readable storage medium having stored instructions which, when executed by the at least one processor, cause the at least one processor to:
maintain a context-based distributed cache for a containerized workload of a multi-tenant point-of-sale (POS) system managed on a tenant hosting device of a processing environment associated with the multi-tenant POS system;
maintain transaction data within the context-based distributed cache without a data schema associated with the transaction data; and
dynamically scale resources associated with the containerized workload and the context-based distributed cache based on performance metrics associated with the processing environment.

20. The system of claim 19, wherein the at least one processor is further configured to:
enable automatic switching from the tenant hosting device to a different tenant hosting device based on real-time resource assessments, ensuring continuous and uninterrupted operation of the containerized workload and the context-based distributed cache.
